(19) United States
(12) Patent Application Publication
(10) Pub. No.: US 2018/0175513 A1
(43) Pub. Date: Jun. 21, 2018

(54) HIGH FREQUENCY POLYMER ON METAL RADIATOR

(71) Applicant: Raytheon Company, Waltham, MA (US)

(72) Inventors: Robert S. Isom, Allen, TX (US); Andrew J. Marquette, Redondo Beach, CA (US); Jason G. Milne, Hawthorne, CA (US)

(73) Assignee: Raytheon Company, Waltham, MA (US)

(21) Appl. No.: 15/379,775

(22) Filed: Dec. 15, 2016

(51) Int. Cl. H01Q 21/06; H01Q 25/00; H01Q 21/00; H01Q 21/22; H01Q 9/04

(52) U.S. Cl. CPC H01Q 21/062; H01Q 25/001; H01Q 9/0492; H01Q 21/0087; H01Q 21/22; H01Q 21/0006

(57) ABSTRACT

In one aspect, a unit cell of a phased array antenna includes a metal plate having a hole, a first side and a second side opposite the first side, a first plurality of laminate layers disposed on the first side, a second plurality of layers disposed on the second side of the metal plate, a radiator disposed in the first plurality of layer on the first side, a feed circuit disposed in the second plurality of laminate layers on the second side and configured to provide excitation signals to the radiator and a first plurality of vias extending through the hole connecting the feed circuit to the radiator.

### GOVERNMENT RIGHTS

This invention was made with U.S Government support. The Government has certain rights in the invention.

### BACKGROUND

Performance of an array antenna is often limited by the size and bandwidth limitations of the antenna elements which make up the array. Improving the bandwidth while maintaining a low profile enables array system performance to meet bandwidth and scan requirements of next generation of communication applications, such as software defined or cognitive radio. These applications also frequently require antenna elements that can support either dual linear or circular polarizations.

### SUMMARY

In one aspect, a unit cell of a phased array antenna includes a metal plate having a hole, a first side and a second side opposite the first side, a first plurality of laminate layers disposed on the first side, a second plurality of layers disposed on the second side of the metal plate, a radiator disposed in the first plurality of layer on the first side, a feed circuit disposed in the second plurality of laminate layers on the second side and configured to provide excitation signals to the radiator and a first plurality of vias extending through the hole connecting the feed circuit to the radiator.

In another aspect, a method of manufacturing a unit cell of a phased array antenna includes machining a metal plate to have at least one hole, filling the at least one hole with a laminate, adding a first plurality of laminate layers to a first surface of the metal plate, adding a second plurality of laminate layer to a second surface of the metal plate opposite the first surface, adding a radiator in the first plurality of layer on the first side; adding a feed circuit in the second plurality of laminate layers on the second side and configured to provide excitation signals to the radiator and adding a plurality of vias extending through the hole connecting the feed circuit to the radiator.

### DESCRIPTION OF THE DRAWINGS

FIG. 1A is a diagram of an example of a phased antenna array.

FIG. 1B is a diagram of an example of a unit cell of the phased array antenna.

FIG. 1C is a diagram of the unit in FIG. 1 without a metal plate.

FIG. 1D is a diagram of an example of the unit cell without the wide-angle impedance matching layer.

FIG. 2A is a diagram of an example of a metal plate used, for example, for shielding.

FIG. 2B is a diagram of an example of the metal plate of FIG. 2A with vias and a feed circuit.

FIG. 3 is a top view of an example of a feed circuit.

FIG. 4 is a top view another example of a feed circuit.

FIG. 5 is a flowchart of an example of a process to manufacture the unit cell.

### DETAIL DESCRIPTION

Described herein is a phased array antenna that includes one or more unit cells. In one example, the unit cell includes a high frequency radiator fabricated in a polymer-on-metal (POM) structure.

The unit cell described herein provides one or more of the following advantages. The unit cell provides out-of-band filtering and shielding inherently. The unit cell is well grounded, low profile structure that controls surface wave propagation extended frequency and scan performance. The unit cell provides excellent axial ratio performance over scan out to 60°. High density thin film metallization on a laminate achieves 0.002″ linewidths and gaps. The unit cell has thermal management benefits due to a metal plate.

Current loop radiators have been successfully realized in printed wiring board (PWB) technology from frequencies ranging from C-band to K-band. At Ka-band and above it becomes difficult to maintain performance due to the sensitivity of the radiator performance to via location and the need for smaller gaps and linewidths. In PWB technology, via location from nominal can vary within a 0.01″ diameter circle centered on nominal, meaning that vias can move as much as 0.005″ in any direction. As frequency increases, the wavelength and unit cell decrease, so this movement becomes more significant. Additionally, PWB technology has difficulty realizing linewidths and gaps below 0.004″ due to limitations of the processing and equipment. The approach described herein enable producible current loop elements for high frequencies.

Polymer on Metal (POM) technology offers the needed improvement. High density thin film metallization on a liquid crystalline polymer (LCP) attached to a metal plane can achieve 0.002″ linewidths and gaps. Misregistration of these metallization layers is greatly reduced compared to PWB technology, which helps reduce maximum via movement from 0.005″ to <0.001″. Additionally, vias are made with precision laser micro-machining, not drill bits. This combination of improvements provides the ability to realize current loops at much higher frequencies than was possible before. POM technology offers additional advantages in thermal management and shielding. Because the radiator circuit is constructed around a metal plate of significant thickness (e.g., 0.02″), it possesses waveguide-like frequency rejection properties for out-of-band frequencies. Construction can be simplified by placing the feed circuitry on one side of the metal plate and the radiating structure on the other. This simplifies fabrication of the POM circuitry and reduces fabrication cost by reducing the number of laminations required.

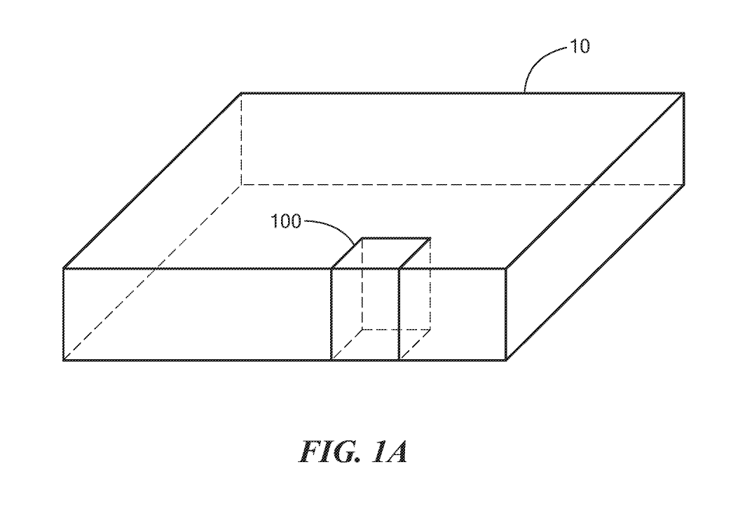

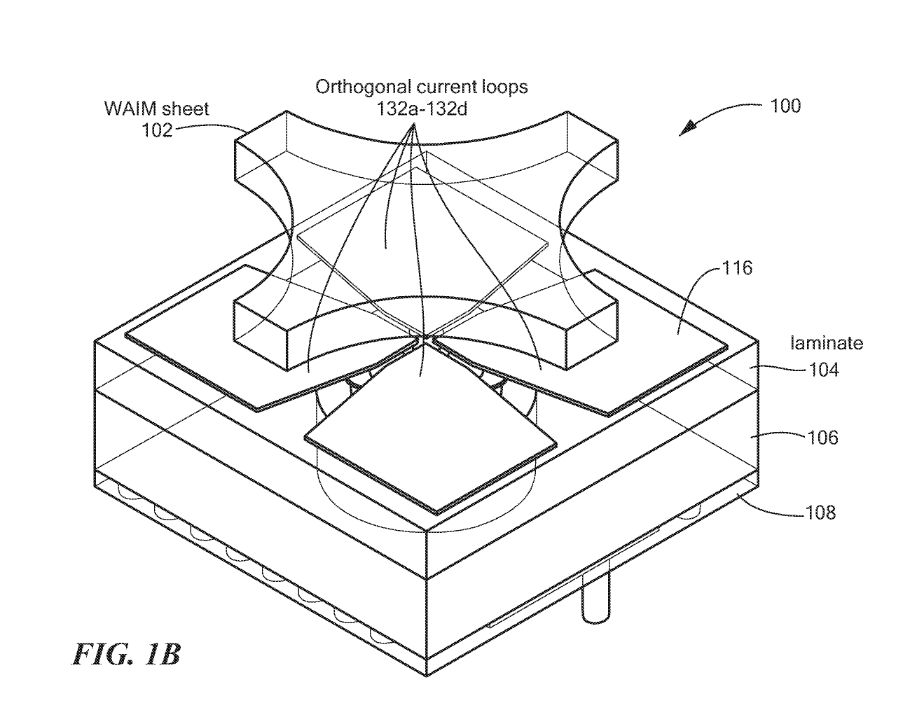

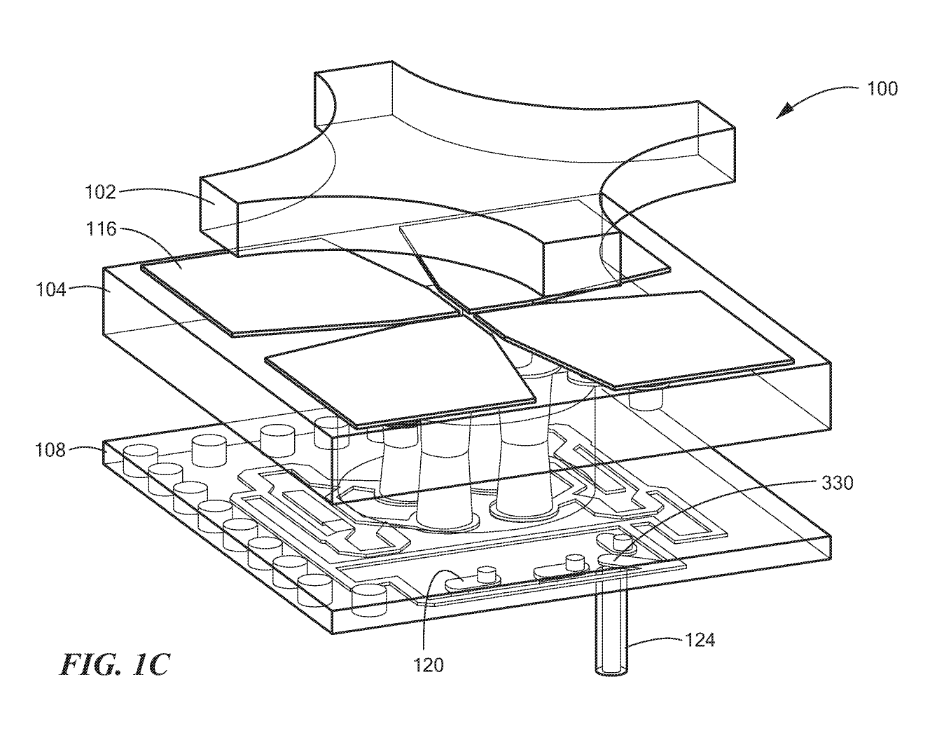

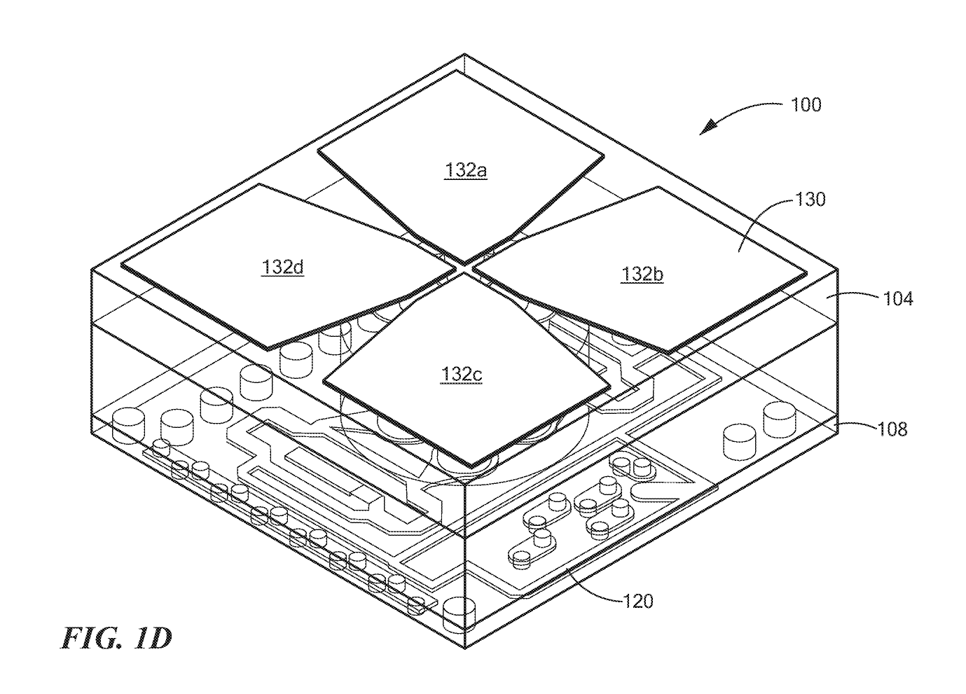

Referring to FIG. 1A, a phased array antenna 10 includes unit cells (e.g., a unit cell 100). In some examples, the phased array antenna 10 may be shaped as a rectangle, a square, an octagon and so forth.

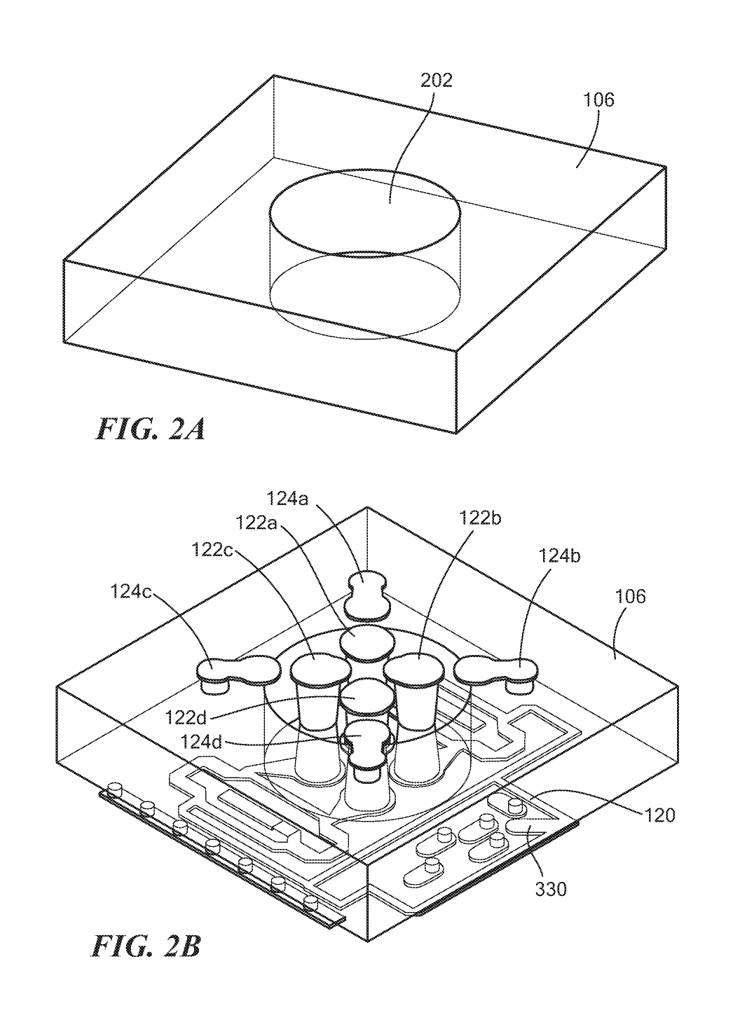

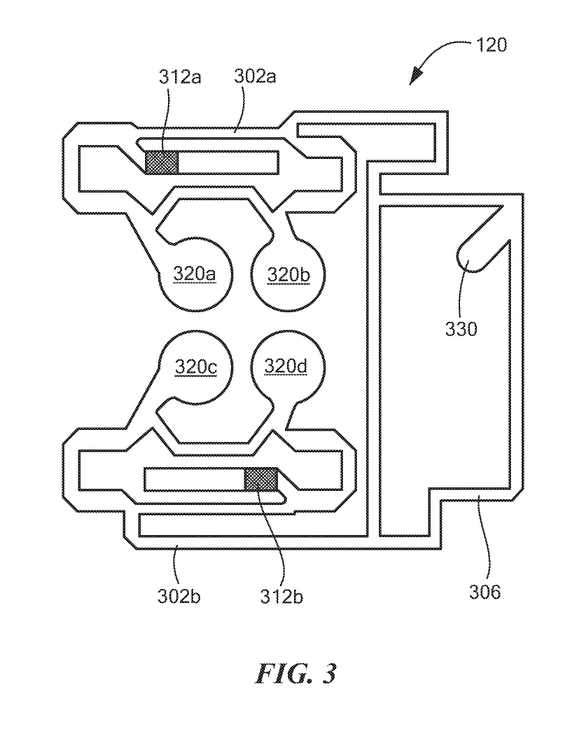

Referring to FIGS. 1B to 1D, in one example, the unit cell 100 includes a wide-angle impedance matching (WAIM) layer 102, a first laminate region 104, a metal plate 106, a second laminate region 108, a radiator 116 with orthogonal current loops 132a-132d and a quadrature phase feed circuit 120. The unit cell 100 also includes vias (e.g., vias 122a-122d (FIG. 2B)) that provides excitation signals from the feed circuit 120 to the radiator 116, which, for example, controls surface waves and improves the bandwidth of the radiator and its performance over scan. The feed circuit 120 includes a coaxial port 330 that receives signals provided by an RF connector 124.

In one example, the WAIM sheet is a 0.01″ Cyanide Ester resin/quartz pixelated WAIM. In one example, the first laminate region 104 and the second laminate region 108 are liquid crystalline polymer (LCP) laminates. The first laminate region 104 may include one or more layers of laminate. The second laminate region 108 may include one or more layers of laminate. As will be further described herein, metallization (including vias 122a-122d) may be added after a laminate layer is added. For example, the vias 122a-122d are formed in stages.

Referring to FIGS. 2A and 2B, the metal plate 106 includes at least one hole 202. In one example, the metal plate is a shield. In one example, the metal plate includes a nickel-iron alloy such as is 64FeNi or Invar. The presence of the hole 202 produces a waveguide-like component to the current loop radiator 116, which can be used to improve key performance parameters by controlling the spacing of the vias 122a-122d from each other and the metal wall plus the depth and diameter of the hole 202 in the metal plate 106.

Each of the dipole arms 132a-132d is grounded to the metal plate 106 by a corresponding via. For example, the dipole arm 132a is grounded using a via 124a, the dipole arm 132b is grounded using a via 124b, the dipole arm 132c is grounded using a via 124c and the dipole arm 132d is grounded using a via 124d. In one example, one or more of the vias 132a-132d are added at a particular distance from a respective via 124a-124d to control tuning.

In one example, the vias (e.g., vias 122a-122d and vias 124a-124d) are micromachined laser vias that allow high accuracy placement of the vias that reduce performance variations in the built part. It is important to the successful design of the radiator that the layers of the stackup are implemented in such a way that the vias needed can be realized as required for radiator performance, particularly, balancing such elements as the diameter of the hole 202 in the metal plate 106 to be large enough that the four signal vias 122a-122d between the feed circuit 120 and the radiator 116 can be realized and small enough that the ground vias 124a-124d between the radiator circuit layer 116 and the metal plate 106 can be placed close enough to the signal vias 122a-122d to be effective at eliminating the propagation of surface waves in the dielectrics (e.g., laminates).

Referring to FIG. 3, the quadrature feed circuit 300 includes branch couplers 302a, 302b coupled to a rat-race coupler 306. The branch coupler 302a includes pads 320a, 320b and a resistor 312a; and the branch coupler 302b includes pads 320c, 320d and a resistor 312b. The resistors 312a, 312b may be selected to control isolation between the branch couplers 202a, 202b, which improves scan performance.

The pads 320a-320d are connected to a corresponding one of the radiator dipole arms 132a-132d using the vias 122a-122d (FIG. 2B) to provide 0°, 90°, 180°, 270° excitation of the radiator. The rat-race coupler 306 includes the coaxial port 330 to receive signals from the RF connector 124. In one example, the difference in phase between the signals provided to pads 320a, 320b is 90° and the difference in phase between the signals provided to pads 320c, 320d is 90°. In one particular example, the feed circuit 120 provides signals to the dipole arms 132a-132d using right hand circular polarization (RHCP).

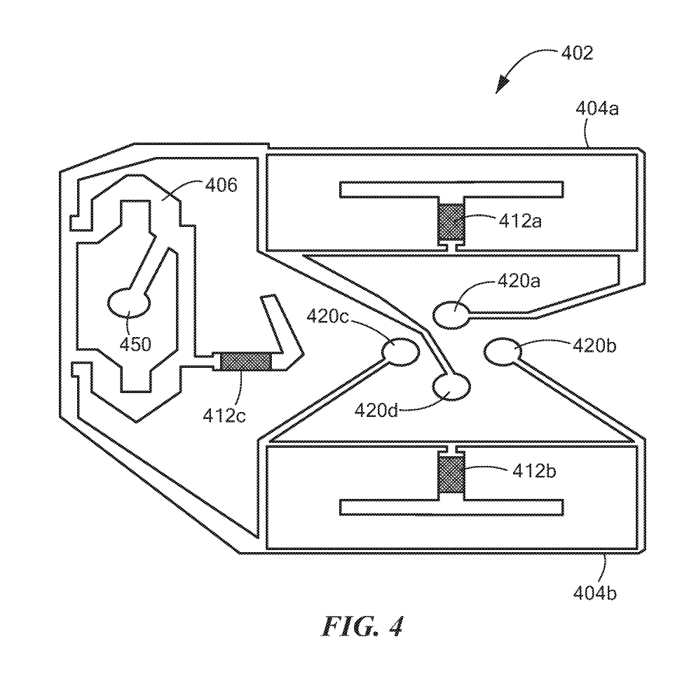

Referring to FIG. 4, another example of a quadrature phase feed circuit is the feed circuit 402. The quadrature feed circuit 300 includes rat-race couplers 404a, 404b coupled to a branch coupler 406. The rat-race coupler 404a includes pads 420a, 420c and a resistor 342a; and the rat-race coupler 404b includes pads 420b, 420d and a resistor 312b. The branch coupler 406 includes a resister 412c and a pad 450.

The resistors 412a-412c provide isolation between the first rat-race coupler 402a, the second-rat-race coupler 402b and the branchline coupler 406, which improves scan performance. The branch coupler 406 is connected to the RF connector 124 at the pad 450.

The pads 420a-420d are connected to a corresponding one of the radiator dipole arms 132a-132d using the vias 122a-122d (FIG. 2B) to provide 0°, 90°, 180°, 270° excitation of the radiator. The signals to the dipole arms 132a, 132c are 180° out of phase from one another and the signals to the dipole arms 132b, 132d are 180° out of phase from one another. In one example, the signals to the dipole arms 132a, 132b are 90° out of phase from one another and the signals to the dipole arms 132c, 132d are 90° out of phase from one another. In one particular example, the feed circuit 402 provides signals to the dipole arms 132a-132d using right hand circular polarization (RHCP).

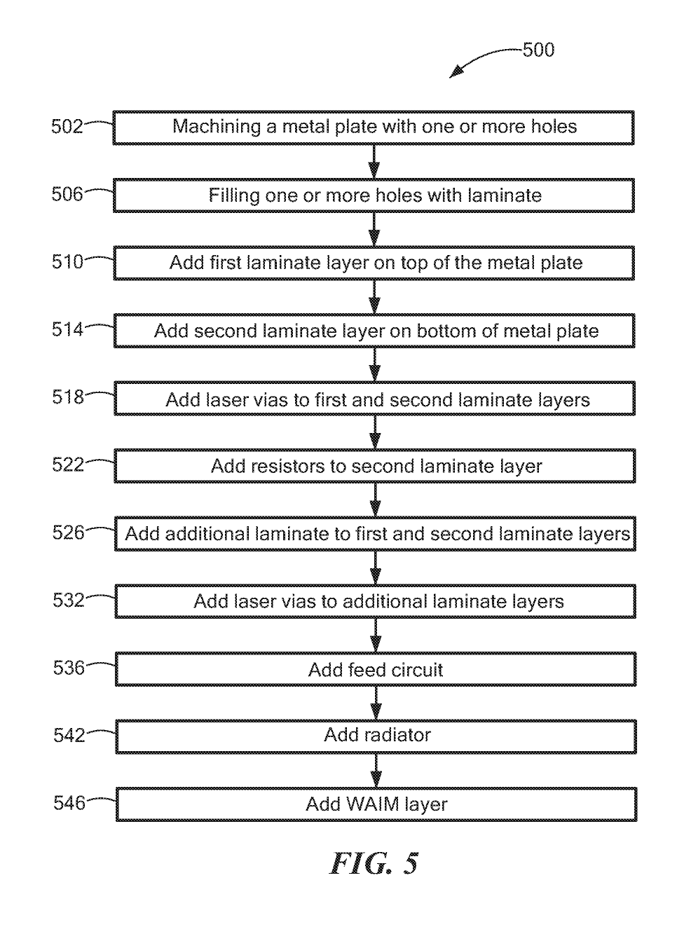

Referring to FIG. 5, a process 500 is an example of a process to manufacture a unit cell 100. Process 500 machines a metal plate with one or more holes (502). For example, the metal plate 106 with the hole 202 is formed using wire electrical discharge machining (EDM) or a hole 202 is machined out from the metal layer 106.

Process 500 fills one or more of the holes (506). For example, the hole 202 of the metal plate 106 is filled with an LCP.

Process 500 adds a first laminate layer to a top surface of the metal plate (510). For example, a first laminate layer of LCP is added to the top surface of the metal layer 106. In one particular example, 0.004′ of LCP is added.

Process 500 adds a second laminate layer to a bottom surface of the metal plate (514). For example, a second laminate layer of LCP is added to the bottom surface of the metal layer 106. In one particular example, 0.002′ of LCP is added.

Process 500 adds laser vias to the first and second laminate layers (518). In one particular example, the first and second layers are patterned for the laser vias. For example, 0.01″ laser vias are added to the first and second laminate layers. In another example, 0.006″ laser vias are added to the first laminate layer 104 and 0.003″ laser vias are added to the second laminate layer 108. In one example, the staggered 0.003″ laser vias are or grounding where the larger via size would be unable to fit.

Process 500 adds resistors to the second laminate layer (522). For example, resistors (e.g., 25 Ohms per square material (OPS)) are added to the second laminate layer 108. In one example, the resistors include the resistors 312a, 312b in the feed circuit 120.

Process 500 add additional laminate to the first and second laminate layers (526). For example, 0.002″ of LCP is added to the second laminate layer 108 and 0.008″ of LCP is added to the first laminate layer 104.

Process 500 adds laser vias to the additional laminate layers (532). In one particular example, the first and second layers 104, 108 are patterned for the laser vias. In another example, 0.003″ and 0.006″ laser vias are added to the second laminate layer 108 and 0.008″ laser vias are added to the first laminate layer 104. In one example, with the formation of the 0.008″ laser vias that are stacked on top of the 0.008″ vias added (see, for example, processing block 518), the signal vias 122a-122d are completed.

Process 500 adds the feed circuit (536). For example, the feed circuit 120 is formed, using metallization, to connect to the signal vias 122a-122d.

Process 500 adds the radiator (542). For example, the radiator 116 is formed, using metallization, to connect to the ground vias 124a-124d and the signal vias 122a-122d

Process 500 add WAIM layer (546). For example, the WAIM layer 102 is added and place above the first laminate region 104 leaving an air gap of 0.02″ between the first laminate region 104 and the WAIM layer 102.

The processes described herein are not limited to the specific examples described. For example, the process 500 is not limited to the specific processing order of FIG. 5. Rather, any of the processing blocks of FIG. 5 may be re-ordered, combined or removed, performed in parallel or in serial, as necessary, to achieve the results set forth above.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A unit cell of a phased array antenna comprising:
a metal plate having a hole, a first side and a second side opposite the first side;
a first plurality of laminate layers disposed on the first side;
a second plurality of layers disposed on the second side of the metal plate;
a radiator disposed in the first plurality of layer on the first side;
a feed circuit disposed in the second plurality of laminate layers on the second side and configured to provide excitation signals to the radiator; and
a first plurality of vias extending through the hole connecting the feed circuit to the radiator.

2. The unit cell of claim 1, wherein the metal plate comprises a nickel-iron alloy.

3. The unit cell of claim 2, wherein the nickel-iron alloy is 64FeNi.

4. The unit cell of claim 1, wherein the radiator comprises:
a first dipole arm;
a second dipole arm;
a third dipole arm; and
a fourth dipole arm.

5. The unit cell of claim 4, wherein the plurality of vias comprises:
a first via coupled to the first dipole arm;
a second via coupled to the second dipole arm;
a third via coupled to the third dipole arm and
a fourth via coupled to the fourth dipole arm,
wherein the first, second, third and fourth vias provide the excitation signal from the feed circuit.

6. The unit cell of claim 5, wherein the feed circuit comprises:
a first branchline coupler coupled to the first via and the second via;
a second branchline couple coupled to the third via and the fourth via;
a rat-race coupler coupled to the first and second branchline couplers.

7. The unit cell of claim 6, wherein the feed circuit further comprises:
a first resistor coupled to the first branchline coupler; and
a second resistor coupled to the second branch coupler; and
wherein the first and second resistors provide isolation between the first branchline coupler and the second branchline coupler.

8. The unit cell of claim 5, wherein the feed circuit comprises:
a first rat-race coupler coupled to the first via and the third via;
a second rat-race couple coupled to the second via and the fourth via;
a branchline coupler coupled to the first and second rat race couplers.

9. The unit cell of claim 7, wherein signals to the first and third dipole arms are 180° out of phase from one another, and
wherein signals to the second and fourth dipole arms are 180° out of phase from one another.

10. The unit cell of claim 9, wherein signals to the first and second dipole arms are 90° out of phase from one another, and
wherein signals to the third and fourth dipole arms are 90° out of phase from one another.

11. The unit cell of claim 8, wherein the feed circuit further comprises:
a first resistor coupled to the first rat-race coupler;
a second resistor coupled to the second rat-race coupler; and
a third resistor coupled to the branchline coupler,
wherein the first, second and third resistors provide isolation between the first rat-race coupler, the second-rat-race coupler and the branchline coupler.

12. The unit cell of claim 5, further comprising:
a fifth via coupled to the first dipole arm;
a sixth via coupled to the second dipole arm;
a seventh via coupled to the third dipole arm and
an eighth via coupled to the fourth dipole arm,
wherein the fifth, sixth, seventh and eighth vias provide ground.

13. The unit cell of claim 1, wherein the feed circuit is a quadrature phase feed circuit.

14. The unit cell of claim 1, wherein the feed circuit supplies signals to the radiator using right hand circular polarization (RHCP).

15. The unit cell of claim 1, wherein at least one of the first laminate layer and the second laminate layer is a liquid crystalline polymer (LCP).

16. The unit cell of claim 1, further comprising a wide-angle impedance matching sheet (WAIM) disposed near the first laminate layer.

17. The unit cell of claim 1, wherein the unit cell performs at Ka-band or higher frequencies.

18. A method of manufacturing a unit cell of a phased array antenna, comprising:
machining a metal plate to have at least one hole;
filling the at least one hole with a laminate;
adding a first plurality of laminate layers to a first surface of the metal plate;
adding a second plurality of laminate layer to a second surface of the metal plate opposite the first surface; and
adding a radiator in the first plurality of layer on the first side;
adding a feed circuit in the second plurality of laminate layers on the second side and configured to provide excitation signals to the radiator; and
adding a plurality of vias extending through the hole connecting the feed circuit to the radiator.

19. The method claim 18, further comprising adding a wide-angle impedance matching sheet (WAIM) disposed near the first plurality of laminate layers.

20. The method of claim 18, further comprising adding resistors to the second laminate layer.
